(19) United States
(12) Patent Application Publication
(10) Pub. No.: US 2007/0229569 A1
(43) Pub. Date: Oct. 4, 2007

(54) Printer carriage jam or stall detection

(75) Inventor: Kevin James Cowling, Lander, WY (US)

Correspondence Address: Watts Hoffmann, Co., L.P.A., Suite 1750, 1100 Superior Avenue, Cleveland, OH, 44114-2518, US

(73) Assignee: PERTECH RESOURCES INC.

(21) Appl. No.: 11/475,305

(22) Filed: Jun. 27, 2006

Related U.S. Application Data
(60) Provisional application No. 60/787,994, filed on Mar. 31, 2006.

(51) Int. Cl. B41J 29/393; B41J 23/00

(52) U.S. Cl. 347/19; 347/37

(57) ABSTRACT

Carriage jams in a printer are detected by monitoring a centrally mounted home flag sensor. The flag is molded integral with, or attached to the print head carriage. An interruptive optical sensor is secured to the printer mechanism and positioned to straddle the carriage flag and relatively in the center of print field as the carriage is driven back and forth across the printer. The printer controller uses this sensor's signals to place the print head in a home position when the printer is turned on. This sensor's signals are also used to detect a carriage jam condition. A jam detection method is performed with each pass of the carriage through the sensor to detect carriage position errors and jams that may result in data loss, illegible documents, misaligned print, document destruction, or damage to printer components.

### CROSS-REFERENCE TO RELATED APPLICATIONS

This application claims the benefit of priority from U.S. Provisional Patent Application Ser. No. 60/787,994 filed on Mar. 31, 2006, which is incorporated herein by reference in its entirety for all purposes.

### TECHNICAL FIELD

This invention relates to the field of printers and more particularly to printers having a moving print head carriage that is driven in a linear excursion across the print media by a motor or other locomotive means.

### BACKGROUND

In the field of printing, detecting carriage jams is valued for several reasons. The continued force of driving the carriage motor after a jam may cause physical damage to the print head, its associated mounting structure, or other carriage hardware. An undetected jam may result in destruction of important documents that are to be printed on. A momentary jam may cause print images that are illegible, improperly placed or misaligned on documents. Also, data sent to the printer for imaging may be discarded and possibly irretrievable if the printer has not notified the host in a timely manner that the data has not been successfully printed.

In the past, carriage jams have gone undetected or have been detected by interruptive sensors placed on the outer far edges of the carriage movement, a comb strip that indicates carriage position, or a code wheel placed on the motor shaft that is used to detect a cessation of motor shaft rotation that may indicate stall. Additionally, a method detecting a jam by sensing current in the carriage drive stepper motor has been used. These implementations have their own limitations. Placing the sensor on a outer edge of the carriage movement requires a full sweep of the carriage to interrupt the sensor. This limits the use of logic seeking for start of print, by limiting the interruption of the sensor to only when the host controller specifically moves the carriage into such sensor or when print image data is sufficient to move the carriage into the sensor. The other options require extra hardware in the carriage area that adds cost and takes up valuable space within the printer.

### SUMMARY

A sensor is mounted at a central location along the line of print such that the carriage should pass in close proximity to the sensor during the printing of most lines. The use of a centrally located sensor allows a single sensor to be used to detect jam conditions and to locate the proper home position of the carriage. The single sensor may also be used to detect a jam condition that only existed momentarily that results in a misalignment between the print head and the print media.

A printer having a centrally located sensor and flag on the moveable carriage is controlled by determining an actual carriage home position by moving the carriage to a position in which the sensor is interrupted and approximating a position relative to the home position using some other indirect mechanism such as electrical motor drive pulses or motor shaft or belt movement. The proper functioning of the printer can be verified by checking that the carriage is interrupting the sensor when the approximated carriage position is the home position.

Accordingly, method is provided that detects a positional error in a printer having a print head mounted to a moving carriage driven by a drive mechanism in which the carriage traverses a linear excursion corresponding to each print line. The method monitors for an occurrence of a carriage homed signal from a sensor, such as, for example, an interruptive sensor, that is fixed on the printer at a location corresponding to a home position at a center region of the linear excursion traveled by the moving carriage. The carriage homed signal is generated when the moving carriage, or a flag mounted to the carriage, passes in close proximity to the sensor during the linear excursion of the carriage. Drive motion signals, such as, for example, pulses from a drive motor, sent from the drive mechanism are monitored to extrapolate an expected position of the carriage based on motion of the drive mechanism. A determination is made as to whether the carriage homed signal is being generated when the expected position is determined to be the home position. The occurrence of a positional error is noted when the expected position of the carriage is determined to be the home position and the carriage homed signal is not detected. It may be advantageous to define the home position a range of positions centered about a center point of the linear excursion. In addition, it may be advantageous to periodically home the carriage by moving the carriage to the carriage home position so that the carriage homed signal is generated and so that a counter that counts the pulses can be zeroed.

A print head carriage monitoring apparatus is provided for a printer that includes a printer base and print head carriage moveable relative to the printer base in which the print head carriage is driven by a drive mechanism to move a print head through a series of substantially linear excursions across a print media. A sensor is fixed to the printer base at a home location approximately coincident with a center of the substantially linear excursion that sends a carriage home signal that is indicative of the carriage passing within a given proximity of the flag sensor. A jam detector receives a drive mechanism motion signal that corresponds to motion of the drive mechanism and monitors for an occurrence of the carriage home signal. The jam detector approximates a position of the print head carriage based on the drive mechanism motion signal and indicates that a printer carriage jam has occurred when the position of the print head carriage has been approximated to be within a given range of the home location and a carriage home signal is not received.

These and other objects, advantages, and features of the exemplary embodiment of the invention are described in detail in conjunction with the accompanying drawings.

### BRIEF DESCRIPTION OF THE DRAWINGS

FIG. 1 is a top perspective view of constructed in accordance with an embodiment of the present invention;

FIG. 2 is a partially cut-away perspective view of the printer of FIG. 1;

FIG. 3 is a close up perspective view of the printhead carrier shown in FIG. 1;

FIG. 4 is a close up perspective view of the printer circuit board and print mechanism base plate shown in FIG. 1;

FIG. 5 is a flowchart outlining a method of homing a printer carriage according to an embodiment of the present invention;

FIG. 6 is a flowchart outlining a method of positioning a printer carriage for start of print according to an embodiment of the present invention;

FIG. 7 is a flowchart outlining a method of moving a printer carriage according to an embodiment of the present invention;

FIG. 8 is a flowchart outlining a method of moving a printer carriage according to an embodiment of the present invention; and

FIG. 9 is a flowchart outlining a method detecting a printer carriage jam according to an embodiment of the present invention.

### DESCRIPTION

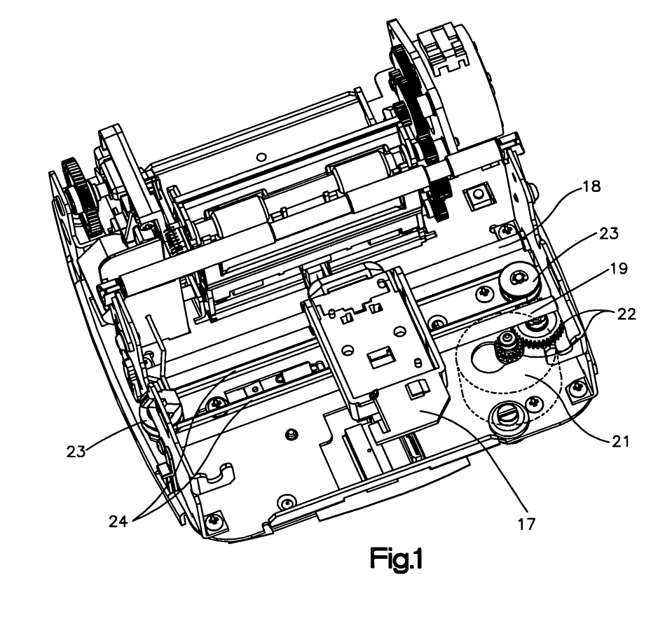

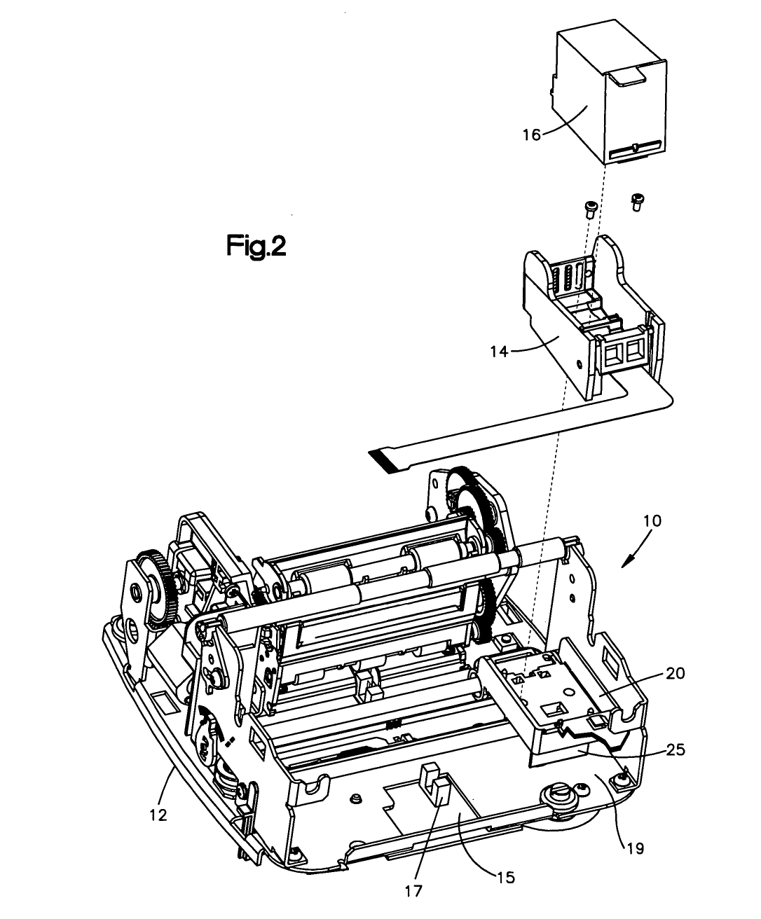

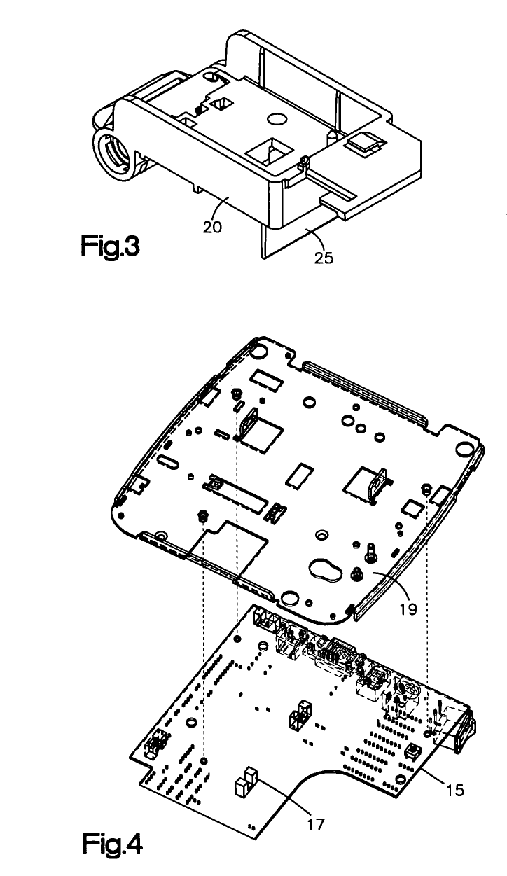

Referring to FIGS. 1-4, a printer 10 is shown with the outer housing removed. The printer has a bi-directional stepper motor 22 (shown in phantom in FIG. 1) that drives an endless toothed belt 24 on drive pulleys 23 via gear train 22. The belt is connected to the carriage and conveys the carriage back and forth in a linear excursion across print media along a line of printing. A flag 25 is molded integral with, or attached to the print head carriage 20. An interruptive sensor 17 is secured to the printer and positioned to straddle the carriage flag 25 and relatively in the center of print field as the carriage is driven back and forth across the print media. A print head 14 is removably mounted in the print head and carries an ink cartridge 16. Below a baseplate 19 of the printer is a circuit board 15 on which control circuitry for the printer is mounted. The interruptive sensor 17 is electrically coupled to the circuit board and protrudes through an opening in the baseplate to lie in the travel path of the print head carriage.

The location of the interruptive sensor in the travel path of the carriage corresponds to a home position for the carriage and is used as a reference point in the control algorithms. A printer controller is also mounted to the circuit board that controls movement of the carriage. The controller receives electrical drive pulse signals from the stepper motor as it rotates or from an associated carriage or stepper motor shaft position sensor that indicate the precise position of the motor shaft. At initialization of the printer, the carriage is moved to the home position, in which the interruptive sensor encounters the flag on the print head carriage. The controller saves this position as home and zeroes a counter that tracks data from the stepper motor. During operation, the controller uses the stepper motor data to predict a position of the carriage. The stepper motor data is tracked and compared with data from the interruptive sensor to determine whether the carriage is located at the home position when the predicted carriage position is determined to be the home position. When the actual carriage home position does not correlate with the predicted carriage home position, a jam has been detected. In this manner the interruption, by the carriage flag, of the sensor or lack thereof is monitored as it relates to the precise position count in the bi-directional movement of the carriage stepper motor. If the interruption occurs too soon in the expected step count or no interruption occurs when expected, a jam occurred and the printer controller stops all carriage operation and declarers a carriage jam fault condition.

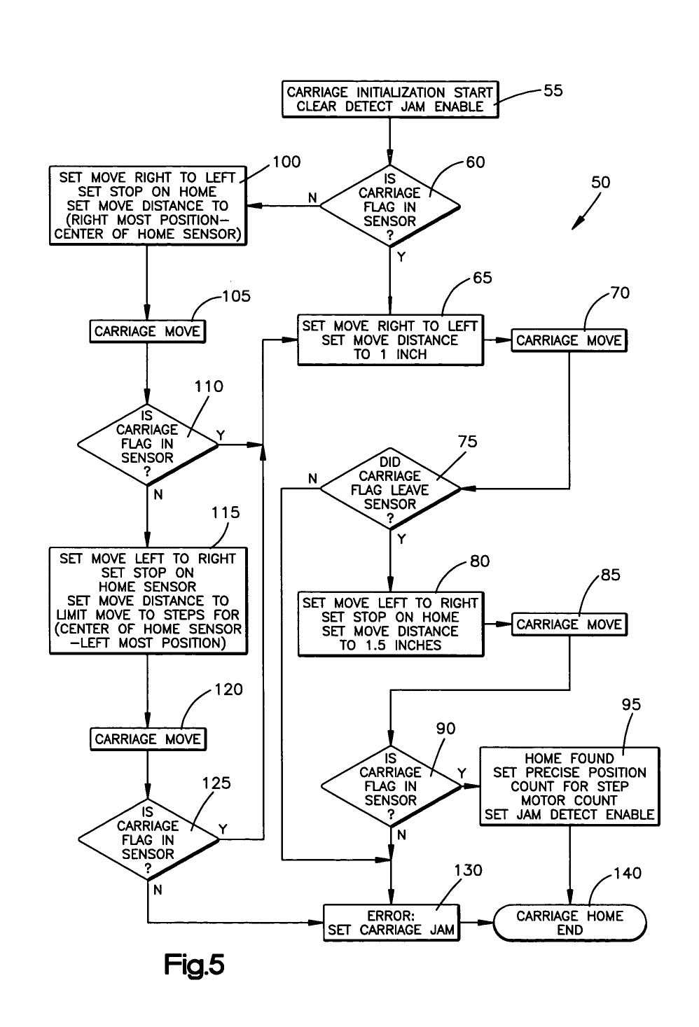

Referring now to FIG. 5, a method 50 for initialization the home position of the print head carriage is shown. At 55 a jam detect enable bit is cleared prior to the start of the homing process. At 60 the condition of the interruptive sensor is checked to determine if the flag is in the sensor, i.e. the carriage is at the home position. If the carriage is at home position, at 65 and 70 the print head carriage is moved by the stepper motor leftwards a distance great enough for the flag to clear the sensor, such as 1 inch which in the described embodiment correlates to 160 motor step signals. At 75 the sensor condition is checked to determine if the flag left the sensor in response to the command to move left. If at 75 it is determined that the flag did not leave the sensor, at 130 a carriage jam bit is set. If the flag left the sensor, as would be expected at 80 and 85 the controller moves the carriage back to the position in which sensor was encountered and at 90 the sensor is checked. If the flag is in the sensor, at 95 the controller sets a precise position count of stepper motor for the carriage and the method ends at 140. From this point on, position count is incremented on every carriage motor step rightward and decremented on leftward steps, in effect, keeping track of carriage position.

If initially at 60 the flag was clear of the sensor, at 100 and 105 the controller moves the carriage leftward up to a distance equal to the distance of carriage rightmost position and the sensor, while looking for interruption of the sensor at 110. If the controller finds the sensor at 110, at 65 and 70 it moves the carriage an additional amount great enough for the flag to clear the sensor. At 110 if the controller did not find the sensor on the leftward move, at 115 and 120 the controller will move the carriage rightward a distance equal to carriage most rightward position. At 125, if the sensor has not encountered the flag, a carriage jam bit is set at 130. If at 125 the sensor signals that it encountered the flag, at 65 and 70 the controller moves the carriage leftward a distance great enough for the flag to clear the sensor. Once the flag is left of the sensor, the controller moves the carriage rightward up to the point the flag interrupts the sensor.

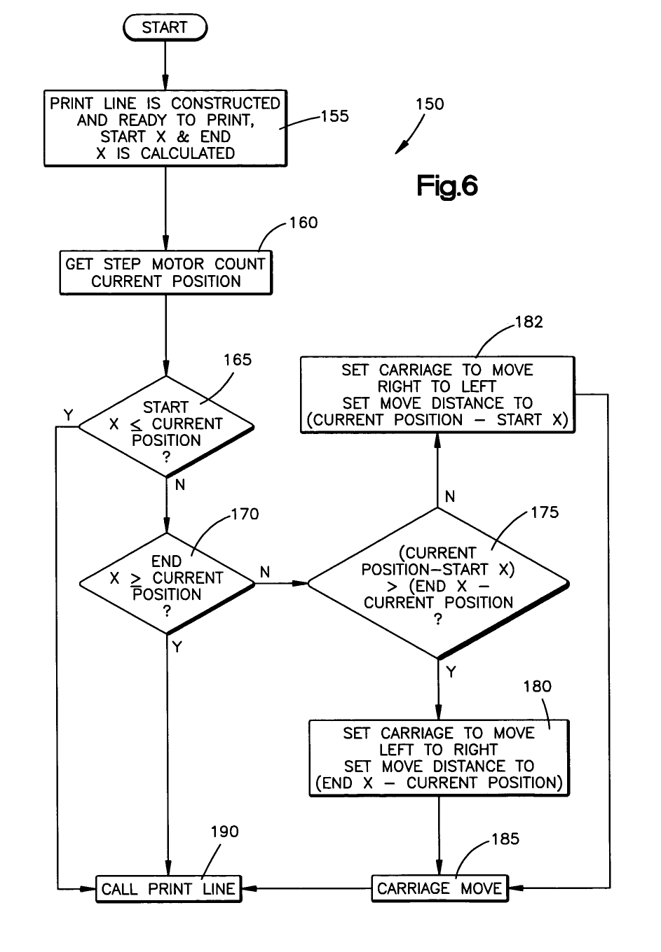

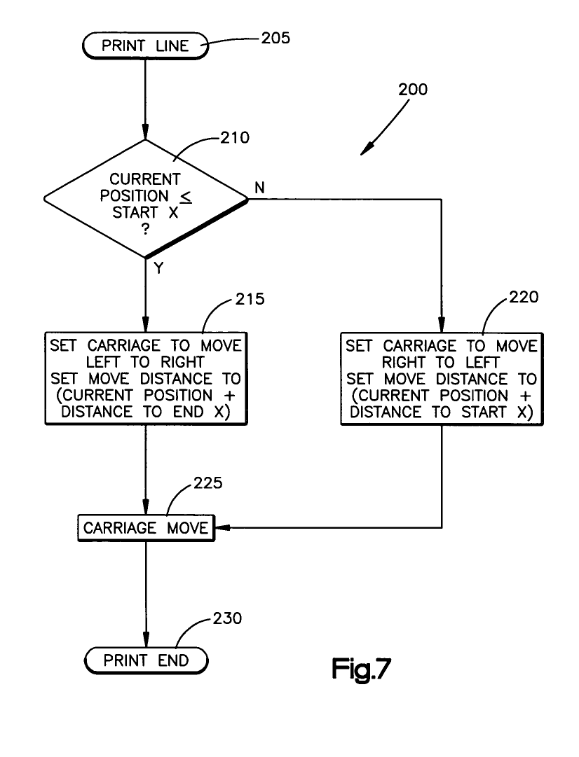

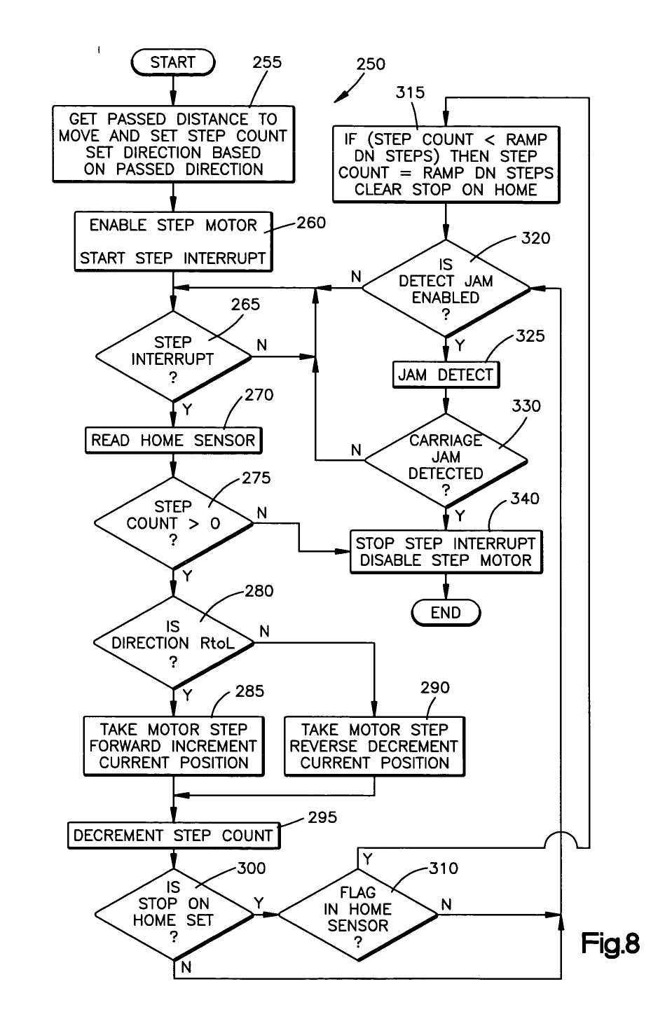

FIG. 6 shows a method for moving a carriage to a position in which a new line of print begins. This method depends on obtaining a true carriage position that was found during the homing method of FIG. 5. At 155, the printer controller passes a constructed print line and the starting X coordinate and the ending X coordinate of the line to be printed to this method. At 160 the controller determines the current stepper motor count which is an indication of the current position of the carriage. At 165 it is determined if the carriage needs to be moved left or right in the least amount of motor steps for start of print. If at 165 the current position is less or equal to that of the start X, the controller jumps straight to the call print line algorithm at 190 (described in more detail in FIG. 7.) If the current position is to the right of or equal to end X at 170, the controller jumps straight to the print line algorithm at 190. If neither of these conditions is met, at 175 it is determined whether the current position minus start X is greater than end X minus current position, (i.e. it is less steps for start of print to begin at end X). If this condition is true at 180 and 185 the controller moves the carriage left to right from current position to the position “end-X” and the print line is called at 190. Otherwise at 182 and 185 the controller moves the carriage right to left from current position to start X and the print line is called at 190.

FIG. 7 is a flowchart outlining a method 200 used by the control to perform an actual print carriage move. At 210 the current position of the carriage is checked. If the current position is less than or equal to start X at 215 and 225 the controller sets a left to right move and a distance equal to current position plus distance to end X. Otherwise, at 220 and 225 the controller sets a right to left move and a distance equal to Current position minus distance to end X. The actual move is performed by implementation of the carriage move algorithm outlined in FIG. 8.

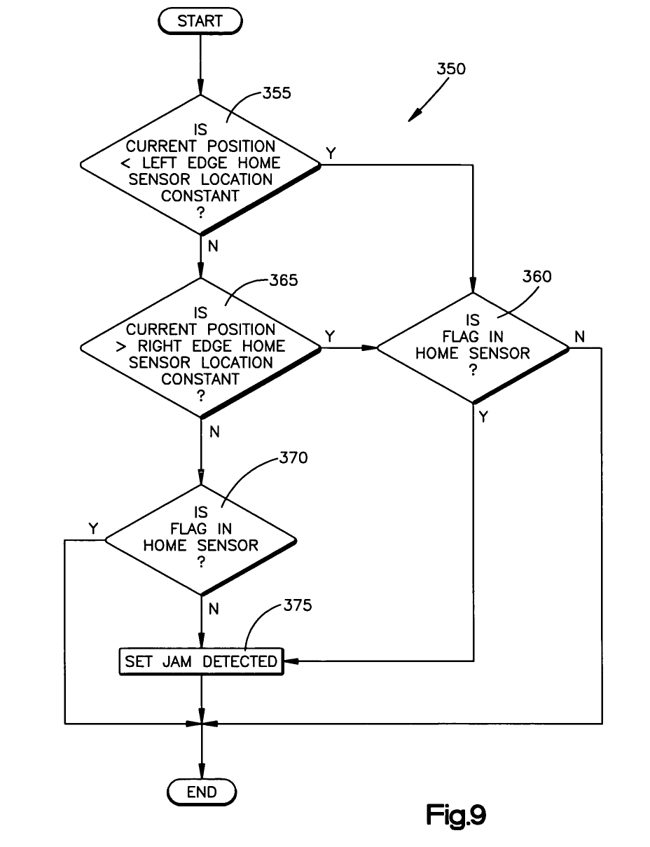

FIG. 8 is a flowchart showing a carriage move method 250. At 255 a distance to move in steps, direction to move (either L to R or R to L), Stop on home flag, and enable Detect jam flag are passed to the method and the step count and direction flag are set. At 260 the stepper motor and the stepper motor interrupt timer are enabled and all further function is then held up until the step interrupt condition occurs as detected at 265. After the step interrupt, at 270 the current state of the home sensor is obtained and stored for later test conditions if needed. At 275 if the step count has reached 0, the stepper motor is disabled, the step interrupt is stopped at 340 and the method is ended. At 275 if the step count is greater than 0, at 280 the direction is tested for right to left. If the direction is right to left at 285 the stepper motor is stepped forward and the current position is incremented. If the direction is not right to left at 280 the motor is stepped in reverse and the current position count is decremented at 290. Regardless of the direction at 280, at 295 the move step counter is decremented. At 300 the stop on home flag is checked and if it is set at 310 the sensor is checked to determine if the flag is in the sensor. If the flag is in the sensor at 315 the most recent prior read of the home sensor is checked. If the flag was in the sensor, the step count is set to immediately ramp down to stop (i.e. ramp down may take 3 steps, so if not already 3 steps or less, the step count is set to 3 steps.) After this, or if the flag was not in the sensor on the most recent prior read of the sensor, at 320 the detect jam algorithm is checked to determine if it is enabled. If the jam detect bit is not enabled, the next step interrupt is awaited at 265. If the jam detect algorithm is enabled, then the jam detect algorithm is called (described in more detail with reference to FIG. 9.) Upon return from the jam detect algorithm, at 330 it is determined if a jam was detected. If no jam was detected the next step interrupt is awaited at 265. If a jam was detected, at 340 stepper motor is disabled, the step count is zeroed, the step interrupt is stopped and the method is ended. The printer controller will the place the printer in a carriage jam fault.

FIG. 9 is a flowchart of a jam detect method 350. At 355 the current position is checked to determine if it is less than left edge home sensor constant. For the purposes of this description, the home sensor left edge constant is a count of 120. If the current position is greater than 120, at 365 the current position is checked to determine if it is greater than right edge home sensor location. Also for the purposes of this description, the right edge constant is a count of 280. If the current position is less than 120 or greater than 280, at 360 the condition of the home sensor is checked and if the flag is in the home sensor, a jam or stall has occurred, and the jam detected fault will be declared at 375. At 370 if the current position is between 120 and 280, and at 370 the flag is determined to be in the sensor, operation is correct and the method is ended.

As described above the printer carriage is monitored for a jam/stall condition by predicting when the carriage flag will be in the sensor based on a controller calculated current position. It can be seen that the method is able to detect a home position as well as a jam condition utilizing no more than a centered mounted interruptible sensor that is already required for home position sense. While the present invention has been described with a degree of particularity, it is the intent that the invention includes all modifications and alterations from the disclosed design falling with the spirit or scope of the appended claims.

1. A method that detects a positional error in a printer having a print head mounted to a moving carriage driven by a drive mechanism, wherein the carriage traverses a linear excursion corresponding to each print line, the method comprising:
monitoring for the occurrence of a carriage homed signal from a sensor fixed on the printer at a location corresponding to a home position at a center region of the linear excursion traveled by the moving carriage, wherein the carriage homed signal is generated when the moving carriage passes in close proximity to the sensor during the linear excursion of the carriage;
monitoring drive motion signals from the drive mechanism to extrapolate an expected position of the carriage based on motion of the drive mechanism;
detecting whether the carriage homed signal is being generated when the expected position is determined to be the home position; and
noting the occurrence of a positional error when the expected position of the carriage is determined to be the home position and the carriage homed signal is not detected.

2. The method of claim 1 wherein the home position is defined as a range of positions centered about a center point of the linear excursion.

3. The method of claim 1 wherein the sensor is an interruptive sensor that includes a flag passageway defined by sensor components and wherein the carriage homed signal is generated when the flag on the carriage passes through the flag passageway in the interruptive sensor.

4. The method of claim 1 wherein the drive motion signals are monitored by counting pulses generated by motion of the drive mechanism, wherein each pulse corresponds to a given linear displacement of the carriage.

5. The method of claim 4 comprising homing the carriage by moving the carriage to the carriage home position such that the carriage homed signal is generated and zeroing a counter that counts the pulses generated by the drive motion sensor such that the expected position of the carriage is extrapolated relative to carriage home position.

6. A print head carriage monitoring apparatus for a printer that includes a printer base and print head carriage moveable relative to the printer base wherein the print head carriage is driven by a drive mechanism to move a print head through a series of substantially linear excursions across a print media, the print head carriage monitoring apparatus comprising:
a sensor fixed to the printer base at a home location approximately coincident with a center of the substantially linear excursion that sends a carriage home signal that is indicative of the carriage passing within a given proximity of the flag sensor; and
a jam detector that receives a drive mechanism motion signal from the drive mechanism that corresponds to movement of the drive mechanism and monitors for an occurrence of the carriage home signal, wherein the jam detector approximates a position of the print head carriage based on the drive mechanism motion signal and indicates that a printer carriage jam has occurred when the position of the print head carriage has been approximated to be within a given range of the home location and a carriage home signal is not received.

7. The apparatus of claim 6 wherein the jam detector approximates a position of the print head carriage by counting drive mechanism pulses wherein each pulse corresponds to a given linear displacement of the carriage.

8. The apparatus of claim 6 comprising a print head position flag fixed to the print head carriage.

9. The apparatus of claim 8 wherein the print head position flag is a tab that protrudes from a lower surface of the print head carriage.

10. The apparatus of claim 9 wherein the sensor is an interruptive sensor that sends a signal when the flag passes through the sensor.

11. Apparatus that detects a positional error in a printer having a print head mounted to a moving carriage driven by a drive mechanism, wherein the carriage traverses a linear excursion corresponding to each print line, the apparatus comprising:
means for generating a carriage homed signal when the moving carriage passes in close proximity to a carriage home position at a center region of the linear excursion traveled by the moving carriage;
means for monitoring for the occurrence of the carriage homed signal;
means for monitoring drive motion signals from the drive mechanism to extrapolate an expected position of the carriage based on motion of the drive mechanism;
means for detecting whether the carriage homed signal is being generated when the expected position is determined to be the home position; and
means for indicating the occurrence of a positional error when the expected position of the carriage is determined to be the home position and the carriage homed signal is not detected.

12. The method of claim 11 wherein the means for generating the carriage homed position comprises an interruptive sensor that includes a flag passageway defined by sensor components and wherein the carriage homed signal is generated when a flag that is fixed to the carriage passes through the flag passageway in the interruptive sensor.

13. The method of claim 11 means for monitoring motion signals is a counter that counts pulses generated by motion of the drive mechanism, wherein each pulse corresponds to a given linear displacement of the carriage.
